(19) United States
(12) Patent Application Publication
(10) Pub. No.: US 2007/0284124 A1
(43) Pub. Date: Dec. 13, 2007

(54) Agricultural implement

(76) Inventor: Edwin L. Ritter III, Wharton, TX (US)

Correspondence Address: W. ALLEN MARCONTELL, P.O. BOX 800149, HOUSTON, TX, 77280-0149, US

(21) Appl. No.: 11/416,678

(22) Filed: May 3, 2006

(51) Int. Cl. A01B 21/02

(52) U.S. Cl. 172/554

(57) ABSTRACT

A wetland foliage cutter designed for towed operation behind an ATV machine has adjustable buoyancy and a vertically adjustable wheel suspension. A tow frame holds a cutter drum for drag rotation about a horizontal rotational axis. A multiplicity of cutter blades are welded to the cutter drums for cutting or crushing wetland foliage as it rolls over it. The tow frame also holds a torsion bar wheel suspension that may be rotated and fixed at a desired angle and height for complete or partial support of the implement weight.

### BACKGROUND OF THE INVENTION

1. Field of the Invention

The present invention relates to mechanical devices for conditioning the wetland habitat of waterfowl. In particular, the invention comprises a towed machine for breaking down excessive vegetation over a shallow waterfield.

2. Description of Related Art

Shallow water wetlands in warm or temperate climates such as are found in the southern United States, are frequently rich in plant nutrients. Consequently, these regions produce a great variety of vegetation. Among these varieties are an abundance of seed and grain plants that provide essential nutrition for migratory waterfowl. In some cases, unfortunately, the sheer abundance of this growth seems to defeat the potential benefit to the waterfowl. In some places, such verdant growth appears to discourage waterfowl presence by possibly creating a canopy that obscures the water beneath the vegetation overgrowth. Additionally, due to the height of this vegetation, the waterfowl have difficulty removing the seed heads for consumption.

To encourage conservation and support of the migratory bird population, it has been proposed to clear or at least thin the vegetation covering significant areas of wetland. Such proposals include removal of the overgrowth in selected areas, or more precisely, breaking down the overgrowth below the water surface level to facilitate feeding and visitation.

Although traditional agricultural machines have been developed and are used to crush and disintegrate the stalks and stems of harvested plants in a traditional farm field, such prior art machines are not suitable for the boggy terrain of wetlands and tidelands.

### SUMMARY OF THE INVENTION

In summary, the invention comprises a towed vehicular implement having a basic box frame with a draft yoke and hitch socket. Transverse of the frame box tow axis, a drum support bar is secured to the frame box. At opposite distal ends of the drum support bar are dependent bearing mounts. A cylindrical chopper drum is secured to the bearing mount ends for free rotation about a horizontally disposed cylindrical axis. A multiplicity of radially projecting chopper blades are secured to the chopper drum surface in a predetermined pattern. The end heads of the drum are perforated by plugged nipples.

Also secured to the frame box, transversely of the tow axis, is a torque bar having wheel struts at opposite distal ends of the torque bar. A retractable wheel suspension comprising wheel struts projecting from a torque bar in a general direction away from the draft yoke. The torque bar is secured to the frame box by journal bearings to accommodate rotation of the torque bar about it's longitudinal axis. Secured to the torque bar at the approximate mid-span is a torque bracket and bracket leg. At the distal ends of the wheel struts are respective wheel forks. Each wheel fork secures a carriage wheel that is mounted for rotation about a horizontal axis that is transverse to the vehicle tow axis.

Spanning between the torque bracket leg and a clevis post secured to a forward element of the frame box is an implement turnbuckle. The distal end of each turnbuckle rod is secured to a clevis connector. One clevis connector is secured by a shear pin to the torque bracket leg whereas the other clevis connector is secured by a shear pin to frame post.

In the wetland environment of a shallow water field, the invention is preferably drawn by a 4-wheeled ATV draft vehicle having large knobby tires for buoyancy and traction. The implement cutting drum is passively driven by the towed movement over field

### BRIEF DESCRIPTION OF THE DRAWINGS

The advantages and further features of the invention will be readily appreciated by those of ordinary skill in the art as the same becomes better understood by reference to the following detailed description when considered in conjunction with the accompanying drawings in which like reference characters designate like or similar elements throughout.

FIG. 1 is a plan view of the invention assembly and

FIG. 2 is a side elevation view of the invention assembly

### DESCRIPTION OF THE PREFERRED EMBODIMENTS

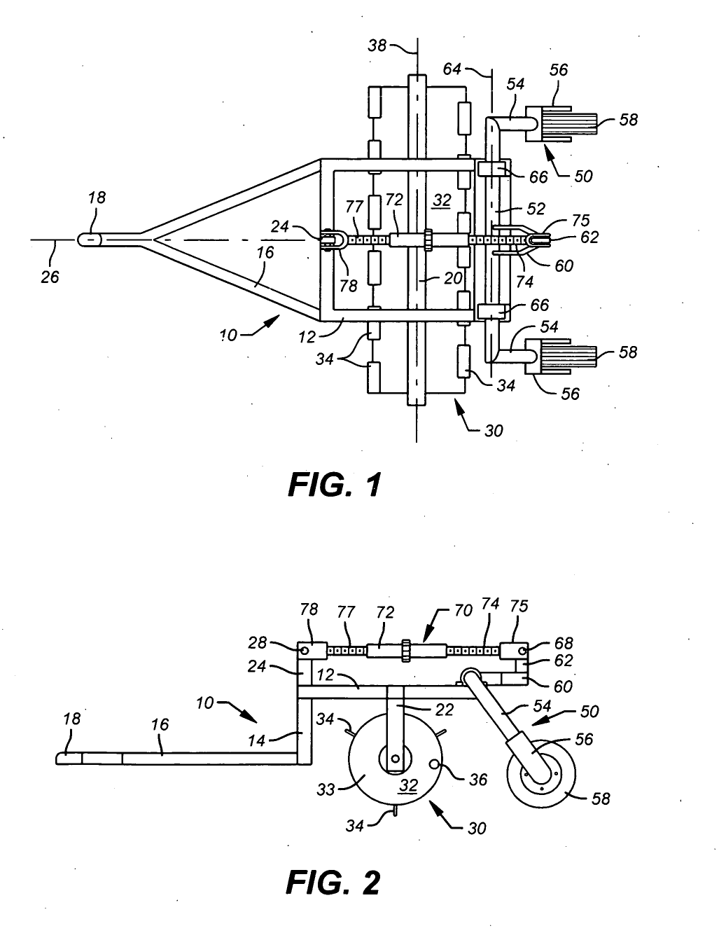

Referring to FIGS. 1 and 2, the invention broadly comprises a frame structure 10 to which a roller drum 30 is secured for rotation about a horizontal cylinder axis 38. Also secured to the frame 10 for limited rotation about a horizontal axis 64 is a retractable wheel suspension assembly 50. A suspension setting turnbuckle 70 secures the suspension assembly wheels 58 at a desired angular position about the horizontal axis 64 relative to the frame 10.

With specific regard to the frame 10, a traditional box construction 12 of welded structural sections such as steel or aluminum tube, channel or I-beam provides a basic assembly platform. A draft yoke 16 has a trailer hitch socket 18 secured to the frontal apex of the yoke. The trailing ends of the draft yoke 16 are secured to the respective bottom ends of a pair of risers 14. The upper ends of the risers 14 are secured to the front corners of the box 12. The length of the risers 14 is determined by the hitch elevation of the desired draft vehicle and the diameter of the roller drum 30 with the objective of keeping the towing force plane roughly horizontal through the roller drum axis 38. A truss strut, not shown, may be secured between the plane of the box 12 and the plane of the draft yoke 16. Approximately along the tow center plane 26, a clevis post 24 is rigidly secured to the topside of the box 12. The clevis post 24 is transversely bored with an aperture to receive a transversely aligned shear pin 28.

The wheel suspension 50 comprises a torque bar 52 having a pair of wheel struts 54 projecting substantially normally from opposite ends of the torque bar. At the distal ends of the wheel struts 54, a wheel fork 56 is secured to thru-axle mount respective wheels 58. The suspension assembly 50 is secured to the frame box 12 by a pair of journal caps 66 aft of the drum support bar 38 for partial rotation about the horizontal axis 64 of the torque bar. Approximately mid-length of the torque bar 52, torque bracket 60 is non-rotatively secured to the torque bar 52 structure as by welding. Upstanding from the torque bracket 60, a bracket leg 62 is welded or otherwise rigidly secured to the bracket 60. Near the distal end of the bracket leg 62, an aperture traverses the bracket leg thickness to receive a shear pin 68.

An implement turnbuckle 70 having clevis connectors 75 and 78 is secured to the bracket leg 62 and clevis post 24 by means of the shear pins 28 and 68. Additionally, the turnbuckle 70 comprises a right-hand threaded rod 74 that supports the end clevis 75 and a left-hand threaded rod 77 that supports the end clevis 78. The right and left-hand threaded rods 74 and 77 are structurally linked by an internally threaded sleeve 72. Rotation of the sleeve 72 over the rotationally fixed rods 74 and 77 advances the rod lengths axially in or out of the sleeve 72 bore in respectively opposite directions. Hence, the suspension wheel 58 may be raised or lowered relative to the horizontal plane of the frame 10 by reducing or increasing the distance between the shear pins 28 and 68.

Those of ordinary skill in the art will recognize that the turnbuckle 70 function may be accomplished by numerous other mechanical devices such as a jack-screw or pressurized fluid strut.

A drum support bar 20 transversely spans the box 12 and is rigidly secured thereto for supporting the bearing mount risers 22 at opposite ends of the bar. The roller drum assembly 30 is secured for rotation between these risers 22 about the cylinder axis 38. The roller drum assembly 30 comprises the drum 32 having end closure heads 33. One or both heads 33 is perforated by a recloseable aperture 36 such as an internally threaded nipple and externally threaded plug. The drum surface carries a multiplicity of radially set chopper blades 34. The alignment pattern of the blades 34 over the surface of the drum 32 may take many forms. The presently preferred embodiment, however, provides a blade of about 6″ to 9″ length and about ¼″ thickness. Blade width as measured from the drum 32 surface radially to the knife edge is preferably about 3″ to 4″. This embodiment sets the blades 34 on the drum surface 32 in three, axially parallel rows spaced 1200 apart around the drum perimeter. Between each blade along a respective row is an approximate 4′ space. The longitudinal placement of the blade-space order is shifted between adjacent rows to assure a full transverse cut for each revolution of the drum.

A non-illustrated, acceptable alternative alignment of the blades 34 may include two or more helical developments over the drum surface with each blade 34 set in parallel alignment with the drum axis 38 but each blade having a helically offset position relative to the adjacent blades. Other alignment patterns are taught within the disclosure scope of U.S. Pat. No. 6,968,907 to R. L. Raper et al, which is incorporated herein.

The present invention is designed and developed to roll down and sever or crush the stalks of native vegetation growing in a flooded wetland impoundment. One of the important invention objectives is to expose open water areas within the vegetated wetland to attract waterfowl visitation. The soil substrate of such impoundments may vary considerably from firmly compacted to a silted bog. Traditional farm machinery is usually too heavy for operation in such an environment. Light duty recreational machines such as All Terrain Vehicles (ATV) equipped with large volume, low pressure tires with raised knob tread patterns are specifically designed for operation under such conditions. Hence, the invention is particularly well suited for operation in tow behind a suitably outfitted ATV machine. Due to the relatively large displacement volume represented by the drum 32 and the low pressure tires of implement wheels 58, the implement may be constructed for partial, or in some cases, full buoyancy. For buoyancy control and, more specifically, control over the force required to cut the wetland foliage against the natural anvil of a boggy bottom, the heads 33 of the drum 32 include a fill nipple 36. To increase the total weight of the implement, water, for example, may be added to the drum 32 interior through the nippled aperture 36 which is closed by a threaded plug.

Not to be overlooked, is the buoyancy of the tires 58. If the tires are filled only with air, for example, the wheel assembly 58 may contribute positively to the overall machine buoyancy. On the other hand, if greater weight is required, the tire casings may be filled with water or even heavier fluids as is often used with traditional agricultural and construction machinery. The buoyancy characteristics of the implement structural elements should also be considered. If those elements are thin wall hollow tube and the joints are all welded fluid tight it may be possible to achieve full frame buoyancy. The same is possible for the suspension assembly 50.

The adjustable position of the of the suspension wheels 58, allows the operator infinite control over the penetration depth of the chopper blades 34. If the wetland substrate is extremely soft and boggy, the wheels may be set to a support plane considerably below the bottom tangent plane of the drum 32 to prevent the drum from becoming mired in the boggy substrate. Additionally, the suspension wheels 58 may be lowered for implement towing over paved roads to prevent damage to either the road or the implement chopper blades 34.

Although the invention has been described in terms of specified and presently preferred embodiments which are set forth in detail, it should be understood that this is by illustration only and that the invention is not necessarily limited thereto. Alternative embodiments and operating techniques will become apparent to those of ordinary skill in the art in view of the present disclosure. Accordingly, modifications of the invention are contemplated which may be made without departing from the spirit of the claimed invention.

1. An implement for conditioning waterfowl habitat comprising:
a main frame to secure the relative positions of dynamic implement elements;
hitch means secured to said frame for selectively coupling said implement to a draft vehicle;
a hollow, fluid tight chopper drum secured to said frame aft of said hitch means for substantially free rotation about a substantially horizontal axis aligned substantially transversely of a vehicle tow axis, said chopper drum having recloseable means for regulating the buoyancy of said implement by entry and retention of a buoyancy regulating fluid internally of said drum, a surface length of said chopper drum having blade means for cutting and/or crushing waterfowl habitat foliage; and,
a vertically variable wheel suspension secured to said frame for supporting a portion of the weight of said implement at a selected height above a support surface

2. An implement as described by claim 1 wherein said wheel suspension comprises a pair of parallel wheel struts projecting from opposite ends of a torque bar, said torque bar being secured to said frame for rotation about an axis substantially parallel with said chopper drum axis.

3. An implement as described by claim 2 having angle adjustment means for setting and holding a predetermined rotational angle of said wheel struts about the torque bar axis.

4. An implement as described by claim 2 having torque bar adjustment means for setting a height of said chopper drum above a support surface.

5. An implement as described by claim 2 wherein said torque bar is secured to said frame by a turnbuckle mechanism.

6. An implement as described by claim 1 wherein said blade means comprise a multiplicity of axially and circumferentially spaced plates secured to said drum surface substantially along a full axial length of said surface with plate widths aligned substantially radially of said drum axis.

7. An implement as described by claim 2 wherein the rotational axis of said torque bar is aft of said chopper drum axis from said hitch means.

8. An implement as described by claim 1 wherein structural elements of said implement comprising said main frame and wheel suspension are substantially buoyant.
